(19) United States
(12) Patent Application Publication
(10) Pub. No.: US 2026/0189410 A1
(43) Pub. Date: Jul. 2, 2026

(54) SILICON-LEVEL HARDWARE ENFORCEMENT SYSTEM FOR LOW-LATENCY STEM CELL AI WITH HARDWARE-ANCHORED SAFETY CONSTRAINTS, MULTIMODAL FUSION, AND SUB-SECOND REVOCATION

(71) Applicant: George William Bickerstaff, III, Greenwich, CT (US)

(72) Inventor: George William Bickerstaff, III, Greenwich, CT (US)

(21) Appl. No.: 19/546,327

(22) Filed: Feb. 21, 2026

(51) Int. Cl. H04L 9/32; H04L 9/00; H04L 9/06; H04L 9/08

(52) U.S. Cl. CPC H04L 9/3278; H04L 9/008; H04L 9/0637; H04L 9/0891; H04L 9/3231; H04L 9/50; H04L 2209/463

(57) ABSTRACT

A silicon-anchored hardware enforcement system enables low-latency, cryptographically gated execution of artificial intelligence for stem cell therapy and regenerative medicine. A Sovereign Identity Token derived from a Physical Unclonable Function (PUF) permanently binds model decryption to a specific hardware instance and restricts execution to a Trusted Execution Environment synchronized to a hardware-protected Safety Epoch. Encrypted AI model weights are decryptable only upon successful hardware validation. Multimodal clinical inputs, including genetic, imaging, and structured patient data, are integrated through a hardware-constrained fusion architecture that operates under enforced biological safety parameters. FPGA-implemented predicate logic evaluates defined biological safety conditions at sub-millisecond latency, and an ASIC-based nullification circuit irreversibly suppresses outputs that violate hardware-defined thresholds within a bounded millisecond response time. A distributed revocation protocol propagates credential invalidation across networked nodes within sub-second latency while preserving reduced-capacity safe mode operation. A permissioned provenance ledger records hardware-attested execution events and supports automated regulatory documentation. The system provides secure clinical deployment, federated research enablement, and verifiable auditability for high-risk therapeutic environments.

### FIELD OF THE INVENTION

The present invention relates to a hardware-optimized platform for sub-millisecond biological safety enforcement in regenerative medicine and stem cell therapy. More specifically, the invention pertains to a silicon-anchored architecture in which encrypted artificial intelligence (AI) model weights are functionally inseparable from a Hardware Security Module (HSM) and gated by Physical Unclonable Function (PUF) challenge-response pairs generated at the silicon level. The system ensures that AI-driven clinical insights remain confined to authorized hardware environments, prevents unauthorized model extraction or tampering, and promotes verifiable compliance with biological safety standards enforced at the silicon level. The invention further integrates PUF-derived session keys with Field-Programmable Gate Array (FPGA)-based predicate logic for real-time ethical validation at sub-10 millisecond response times, and extends to federated clinical deployment across distributed research networks while maintaining hardware-enforced patient data sovereignty.

### BACKGROUND OF THE INVENTION

Artificial intelligence systems applied to regenerative medicine and stem cell therapy create unique safety and security challenges not adequately addressed by prior art. Conventional AI frameworks for biological simulation suffer from what the present inventors term a “Software-Only Vulnerability”: sensitive AI model weights can be extracted, copied, or executed on unauthorized hardware, defeating any attempt to enforce patient safety constraints or data sovereignty at the software layer alone. Once extracted, a model may be operated without the safety guardrails intended by its developers, exposing patients to unvalidated therapeutic recommendations.

Existing approaches to AI model security rely on software-based access controls, encryption schemes managed by general-purpose operating systems, or cloud-based isolation—each of which is susceptible to privileged software attacks, hypervisor escapes, or infrastructure compromise. In clinical and research settings handling sensitive genomic, proteomic, and cellular data, such vulnerabilities create unacceptable risks under HIPAA, GDPR, FDA 21 CFR Part 11, and the Regenerative Medicine Advanced Therapy (RMAT) designation framework.

Furthermore, existing systems lack the ability to enforce biological safety predicates—such as cell viability thresholds, differentiation risk scores, and immunogenicity flags—at hardware speeds. Software-based validation introduces latency that is incompatible with real-time clinical decision support in regenerative therapy monitoring. Prior art revocation systems also fail to propagate credential invalidation across distributed clinical trial networks within clinically relevant time windows.

There exists, therefore, a compelling and unmet need for a system that: (a) cryptographically anchors AI model execution to a physical Root of Trust at the silicon level; (b) enforces biological safety predicates in hardware at sub-millisecond latency; (c) propagates revocation of compromised credentials network-wide in under one second; and (d) maintains a cryptographically verifiable audit trail satisfying FDA, HIPAA, and EU AI Act requirements. The present invention addresses all four requirements in an integrated silicon-to-application stack.

### SUMMARY OF THE INVENTION

The present invention provides a hardware-secured system and method in which AI inference for stem cell and regenerative medicine applications is cryptographically gated by silicon-level physical constraints, rendering model execution on unauthorized hardware cryptographically impossible rather than merely policy-prohibited.

In a first aspect, the invention provides a silicon-anchored execution system comprising a Hardware Security Module (HSM) storing a Sovereign Identity Token permanently bound to device silicon via a Physical Unclonable Function (PUF); a Model Repository storing AI model weights in AES-256-GCM ciphertext; a Trusted Execution Environment (TEE) that refuses decryption when an internal hardware-protected clock deviates from a synchronized Safety Epoch by more than one second; and a decryption gate triggered exclusively by a PUF-derived session key such that execution on non-native silicon produces only cryptographic noise.

In a second aspect, the invention provides a hardware-executed biological validation system comprising an FPGA-based predicate evaluation module performing sub-millisecond safety scoring against biological thresholds; an ASIC-implemented nullification circuit responding to threshold violations in under 10 milliseconds; and a cryptographic binding interface that incorporates patient-specific biomarkers into the nullification circuit via hash chaining, ensuring that safety constraints are device-bound and patient-specific.

In a third aspect, the invention provides a distributed revocation system comprising a hardware-enforced revocation protocol that purges all session keys within 500 milliseconds; a swarm-based gossip propagation mechanism achieving network-wide invalidation across 1,000 nodes in under one second; and a hardware-enforced safe mode maintaining at least 80% operational capacity during partial network degradation.

In a fourth aspect, the invention provides corresponding methods for hardware-anchored AI execution, hardware-executed biological safety validation, and distributed cryptographic revocation, each method step performed by or under the mandatory control of hardware components rather than software alone.

The system integrates a Predicate-Driven Multimodal Fusion Lattice performing tensor decomposition of genetic, imaging, and clinical inputs at O(n log n) computational complexity under hardware-enforced safety constraints; a permissioned blockchain Provenance Governance Ledger requiring multi-party cryptographic approval for any logic modification; and a Regulatory Report Generator that automatically compiles HSM-certified evidence packages satisfying FDA RMAT, 21 CFR Part 11, and EU AI Act Articles 9 and 13 requirements.

### Definitions

For purposes of this application, the following terms have the meanings set forth herein:

“ASIC-Implemented Nullification Circuit” means a dedicated logic-gate circuit fabricated in Application-Specific Integrated Circuits (ASICs) and hardwired to respond to biological safety threshold violations by issuing an irreversible nullification signal within 10 milliseconds, without involving any programmable software layer.

“Biological Safety Predicate” means a hardware-encoded Boolean condition evaluating one or more of: cell viability score, differentiation risk index, immunogenicity probability, genetic instability coefficient, or therapy contraindication flag, against a hardware-defined threshold.

“Execution Layer” means the integrated hardware stack comprising the HSM and TEE, implemented with redundant components targeting 99.99% uptime, wherein no AI inference occurs outside this Layer.

“FPGA-Based Predicate Logic” means hardware-executed evaluation modules implemented in one or more Field-Programmable Gate Arrays, performing real-time evaluation of Biological Safety Predicates at sub-millisecond latency without reliance on a host operating system.

“Hardware-Anchored Execution” means device-bound gating of AI inference functions using cryptographically validated Sovereign Identity Tokens, implemented via constant-time operations resistant to side-channel attacks including power analysis and timing attacks.

“Model Protection Layer” means the framework utilizing AES-256-GCM authenticated encryption with hardware-accelerated decryption exclusively within the TEE, such that plaintext model weights are never present outside the Execution Layer.

“Multimodal Fusion Lattice” means a tensor decomposition architecture that aligns and integrates genetic sequence data, medical imaging tensors, and structured clinical data under hardware-enforced safety constraints, maintaining O(n log n) computational complexity as input dimensionality scales.

“Physical Unclonable Function (PUF)” means a hardware circuit exploiting manufacturing process variations to generate a unique, device-specific challenge-response mapping that cannot be cloned or replicated in software, serving as the root of the Sovereign Identity Token.

“Safety Epoch” means a cryptographically synchronized timestamp maintained by a hardware-protected clock within the TEE, used to detect temporal drift that may indicate replay attacks or hardware substitution.

“Sovereign Identity Token” means a non-clonable device identifier permanently bound to device silicon via a PUF at manufacture time, organized in hierarchical structures to support scalable multi-device clinical deployments, and serving as the sole authorized key material for model decryption.

“Sub-Second Revocation” means a swarm-based propagation protocol implementing optimized gossip mechanisms to invalidate all session keys network-wide across up to 1,000 nodes within one second of a revocation event.

“Substantially Resistant to Bypass” means that compromising the system requires at minimum 2\hat{ }128 computational operations simultaneously against all hardware security layers, quantified per current NIST cryptographic standards.

“Validation Layer” means the hardware module comprising a threshold comparison engine with adaptive calibration capability that refines Biological Safety Predicate thresholds based on federated outcome data without requiring model retraining.

### BRIEF DESCRIPTION OF THE DRAWINGS

The accompanying drawings, which are incorporated in and constitute a part of this specification, illustrate embodiments of the invention and together with the description serve to explain the principles of the invention.

FIG. 1—REGENERATIVE SYSTEM ARCHITECTURE illustrates the top-level silicon-to-application hardware architecture for the regenerative medicine AI enforcement platform, comprising five subsystems arranged in a layered trust hierarchy extending from physical silicon through distributed clinical networking.

FIG. 1A—SILICON ROOT OF TRUST: depicts the foundational hardware subsystem that generates Sovereign Identity Tokens irreversibly bound to device silicon via Physical Unclonable Functions. The subsystem exploits sub-micron manufacturing process variations in each fabricated chip to produce a unique, device-specific challenge-response profile that cannot be replicated by software attack, firmware copying, or physical cloning—even by the original chip manufacturer. The Sovereign Identity Token produced by this subsystem serves as the sole authorized key material for model decryption throughout the Execution Layer. Hierarchical token structures derived from a root trust anchor maintained by an authorized certificate authority support large-scale, multi-site clinical deployments of up to 10,000 hardware nodes, enabling cohesive trust management across geographically distributed institutions without compromising individual device sovereignty. The subsystem interfaces directly with the HSM to store and protect derived token material, and with the TEE to enforce decryption gating. All token generation events are recorded in the Provenance Governance Ledger with hardware-attested timestamps, providing a verifiable chain of custody for every authorized device from manufacture through end-of-life decommissioning.

FIG. 1B—BIOMARKER INGESTION MODULE: depicts the secure multimodal data acquisition subsystem responsible for ingesting, authenticating, and encrypting raw clinical data streams before any downstream AI processing occurs. Incoming genomic sequences, proteomic assay outputs, medical imaging tensors, and structured clinical records are received via TLS 1.3 connections with mandatory forward secrecy, ensuring that intercepted ciphertext cannot be retroactively decrypted even if long-term keys are later compromised. All data streams are encrypted at the point of receipt using AES-256-GCM, with decryption performed exclusively within the Trusted Execution Environment using hardware-accelerated cryptographic engines; plaintext data never traverses memory regions accessible to the host operating system. Differential privacy noise calibrated to (epsilon, delta)-differential privacy bounds is injected into outbound gradient contributions during federated training, preventing gradient inversion attacks that might reconstruct individual patient records from aggregate model updates. Data integrity is continuously validated through hardware-generated hash-based message authentication codes, with any integrity failure triggering immediate session key erasure. Adaptive quorum sizing dynamically adjusts the minimum number of participating nodes required to commit ingested data batches, optimizing the balance between ingestion throughput and distributed verification security based on current network conditions and data sensitivity classifications.

FIG. 1C—FEDERATED CLINICAL NETWORK: depicts the distributed federated learning infrastructure that enables multi-institutional AI model training without exchanging raw patient data across institutional boundaries. Each participating clinical node trains a local AI model instance on locally resident patient data and contributes only differentially-private gradient updates—not raw data or intermediate activations—to the federated aggregation process. Gradient updates are encrypted using partially homomorphic encryption before transmission, permitting the aggregation server to compute gradient sums across all participating nodes without decrypting any individual contribution; the aggregation operation is therefore privacy-preserving by construction, with no single party—including the aggregation server—having access to unencrypted gradients from any other participant. Each gradient submission is cryptographically signed with the contributing node's Sovereign Identity Token, providing hardware-attested provenance that binds every federated contribution to a specific, authenticated physical device. Containerized microservices with hardware-attested identities enable secure hybrid cloud integration, allowing institutions to contribute from on-premise, private cloud, or public cloud infrastructure without sacrificing identity assurance. Adaptive quorum mechanisms—scaling quorum size proportionally to the square root of the active node count—reduce computational overhead by 40% compared to fixed-majority-quorum alternatives while maintaining equivalent Byzantine fault tolerance. All federated training events are recorded in the Provenance Governance Ledger with hardware-attested timestamps, satisfying 21 CFR Part 11 electronic records requirements for the complete model evolution history.

FIG. 1D—PROVENANCE GOVERNANCE LEDGER: depicts the permissioned blockchain infrastructure that provides a cryptographically verifiable, tamper-evident audit trail spanning the entire lifecycle of AI-driven clinical decisions—from raw data ingestion through therapeutic output delivery. The ledger is implemented using cryptographic sharding to distribute audit data storage across multiple ledger nodes, enabling high-throughput write operations for audit events while maintaining sub-second query response times for compliance verification. Each shard is replicated across a minimum quorum of ledger nodes, ensuring that no single node failure can cause data loss or interrupt audit availability. All modifications to core system logic—including updates to Biological Safety Predicate thresholds, model weight repositories, and revocation policies—require multi-party digital signatures from a cryptographic majority (at least 51%) of authorized Governance Nodes before taking effect, ensuring that no single administrator or compromised node can unilaterally alter safety-critical system behavior. Threshold cryptography distributes signing authority such that the cryptographic majority requirement cannot be bypassed by any subset of nodes smaller than the defined quorum. The ledger records each inference session, safety predicate evaluation result, nullification event, federated training contribution, revocation signal, and re-validation event with hardware-attested timestamps and HSM-generated execution certificates. This record constitutes a complete, legally defensible audit trail satisfying FDA RMAT, 21 CFR Part 11, HIPAA Security Rule, EU AI Act Articles 9 and 13, and GDPR Article 30 requirements.

FIG. 1E—SWARM REVOCATION BARRIER: depicts the hardware-anchored credential revocation subsystem responsible for invalidating compromised node credentials across the entire distributed clinical network within clinically relevant time windows. When a revocation event is triggered—by failed TEE attestation, Safety Epoch deviation, administrative command, or automated anomaly detection—the revocation signal is immediately propagated via a gossip-based swarm protocol in which each node that receives the signal re-broadcasts it to a randomized subset of its peer connections. This epidemic-spreading approach achieves network-wide propagation to 1,000 nodes in under one second with sub-500 millisecond median propagation latency, even in partially connected network topologies representing multi-site network partitions or individual node failures. Mathematical analysis using epidemic spreading models confirms 99.9% coverage within 800 milliseconds for networks of up to 1,000 nodes with average node degree of 10. Upon receiving a revocation signal, each node's Hardware Security Module immediately purges all current session key material within a hardware-enforced 500-millisecond latency bound. Hardware interlocks then physically disable HSM decryption operations, preventing any further AI inference, until a re-validation procedure requiring quorum consensus from at least 51% of non-revoked peer nodes is completed. This hardware interlock cannot be overridden by software, including processes with root or kernel privilege.

FIG. 2—CELLULAR DATA PROCESSING FLOW illustrates the five-stage hardware-enforced pipeline through which multimodal clinical data flows from secure acquisition at the network edge through fusion, privacy enforcement, and cryptographic sealing before reaching AI inference and clinical output subsystems.

FIG. 2A—SECURE BIODATA CAPTURE: depicts the edge-layer acquisition subsystem responsible for ingesting raw genetic sequences, proteomic assay outputs, and cellular viability metrics from clinical instrumentation and laboratory information systems. All inbound data connections are established exclusively via TLS 1.3 with mandatory forward secrecy and hardware-attested endpoint authentication, ensuring that the receiving endpoint's identity is cryptographically verified before any clinical data is transmitted. The subsystem employs an ensemble anomaly detection framework combining statistical process control and isolation forest algorithms to identify malformed, out-of-range, or adversarially crafted input records before they enter the processing pipeline; the ensemble is tuned to maintain false positive rates below 1% to minimize interruption to clinical workflows while preserving detection sensitivity against realistic data poisoning attack patterns. Each captured data record is immediately sealed with a SHA-3-256 hash and a hardware-generated timestamp from the TEE's protected clock, establishing an immutable ingestion record in the Provenance Governance Ledger before any downstream processing occurs. This ensures that the provenance chain is established at the point of capture and cannot be retroactively altered regardless of downstream processing failures or security events. Batch ingestion throughput is dynamically regulated by the adaptive quorum mechanism to maintain data consistency guarantees across distributed ledger nodes without introducing backpressure that could delay clinical workflows.

FIG. 2B—FPGA PREDICATE SCREENING: depicts the hardware-executed safety screening stage in which all AI inference outputs are evaluated against the full set of active Biological Safety Predicates before any result is delivered to the clinical interface. Biological Safety Predicates—including cell viability score thresholds, differentiation risk indices, immunogenicity probability bounds, genetic instability coefficients, and therapy contraindication flags—are implemented as combinational logic circuits burned directly into FPGA fabric, not as software routines subject to scheduling delays, OS preemption, or software tampering. This implementation achieves sub-millisecond evaluation latency because predicate circuits operate at FPGA clock rates of hundreds of megahertz, executing complete threshold comparisons within nanoseconds. Adaptive threshold calibration algorithms run in the TEE refine predicate threshold values based on aggregated historical clinical outcome data from the federated network, improving screening accuracy over time without requiring full model retraining or modification of the FPGA fabric. All predicate computation is offloaded entirely to the FPGA logic layer, ensuring that sensitive safety logic is never exposed to the host operating system or to any privileged software process. Any predicate violation immediately triggers the ASIC-Implemented Nullification Circuit, which issues an irreversible suppression signal within 10 milliseconds and logs the event to the Provenance Governance Ledger with a hardware-attested timestamp before any flagged output can reach a clinician.

FIG. 2C—MULTIMODAL FUSION MATRIX: depicts the tensor decomposition stage that aligns and integrates heterogeneous clinical data types into a unified latent representation suitable for AI inference while preserving the semantic relationships between modalities relevant to regenerative therapy planning. The fusion architecture accepts genetic sequence data encoded as high-dimensional feature tensors, medical imaging data represented as volumetric or multi-channel imaging tensors, and structured clinical records encoded as tabular feature vectors, aligning all three modalities into a shared Multimodal Fusion Lattice. Tensor decomposition is performed using an optimized Tucker decomposition algorithm that maintains O(n log n) computational complexity as input dimensionality scales, preventing the quadratic or cubic scaling that characterizes naive tensor operations on high-dimensional clinical inputs. Matrix dimensions—specifically the number of latent factors retained along each mode of the decomposition—adapt automatically to the resolution and completeness of available inputs across modalities, gracefully handling missing or low-quality data from any single modality without requiring the full pipeline to halt. Hardware-enforced safety constraints propagated from the FPGA Predicate Screening stage are embedded as inequality constraints within the decomposition optimization, ensuring that the fused latent representation cannot encode combinations of modality values that would constitute a predicate violation. The resulting fused representation is passed exclusively within the TEE to the AI inference subsystem, preventing any intermediate latent state from being observable outside the Execution Layer.

FIG. 2D—DIFFERENTIAL PRIVACY BARRIER: depicts the federated privacy enforcement stage that protects individual patient identity during distributed model training by injecting calibrated statistical noise into gradient contributions before they leave any participating node. The subsystem implements the Gaussian mechanism for (epsilon, delta)-differential privacy, computing the global sensitivity of the gradient function with respect to the inclusion or exclusion of any single patient's data record and injecting zero-mean Gaussian noise with variance calibrated to achieve the specified (epsilon, delta) privacy budget. Epsilon and delta parameters are tuned at the system level to maintain model utility—measured as area under the ROC curve for the primary clinical prediction task—within 2% of non-private training baselines, ensuring that privacy protection does not materially degrade the clinical value of AI-assisted therapy recommendations. The noise injection computation is performed exclusively within the TEE, preventing any software process from observing or tampering with privacy parameters or injected noise values. All noise injection events are logged with hardware-generated timestamps and privacy budget consumption records to the Provenance Governance Ledger, enabling regulators and auditors to verify that the accumulated privacy budget across all training rounds remains within the system-level (epsilon, delta) commitment. Privacy budget exhaustion detection automatically suspends gradient contributions from any node that has consumed its allocated budget, maintaining formal differential privacy guarantees for the entire federated training session.

FIG. 2E—CRYPTOGRAPHIC HASH LINKAGE: depicts the artifact sealing stage that binds every clinical data record, inference result, predicate evaluation outcome, and audit event into a cryptographically verifiable chain of provenance extending from initial data capture at the biodata acquisition edge through final therapeutic output delivery to the clinical interface. SHA-3-256 hashes are computed over each artifact and organized into a Merkle tree structure, enabling efficient proof of inclusion for any individual record without requiring the verifier to process the entire dataset. Device-specific Sovereign Identity Tokens are embedded in each Merkle tree leaf node, binding every artifact hash to the specific physical device that generated or processed it; any attempt to migrate records from one device to another is detectable as a hash mismatch because the token embedded in the hash is device-specific and non-clonable. The root of the Merkle tree for each processing batch is recorded in the Provenance Governance Ledger with a hardware-attested timestamp, creating an immutable commitment to the full set of artifacts processed during that batch. This chain of cryptographic proof constitutes a legally defensible record of data lineage—documenting which patient data, on which device, under which model version, produced which clinical recommendation—satisfying FDA 21 CFR Part 11 audit trail requirements and EU AI Act Article 9 risk management documentation obligations for high-risk AI systems in medical device contexts.

FIG. 3—THERAPY ADAPTATION CYCLE illustrates the five-subsystem hardware-supervised loop through which the AI model continuously evaluates therapeutic safety, detects distributional drift in clinical inputs, recalibrates model parameters under cryptographic multi-party validation, distributes updates securely to all nodes, and verifies platform integrity via remote attestation.

FIG. 3A—HARDWARE SAFETY EVALUATOR: depicts the hybrid neural-logic evaluation module that constrains probabilistic AI model outputs within hardware-defined biological safety ranges before any recommendation is surfaced to a clinician. The evaluator combines a neural network scoring layer operating within the TEE with a hardware-enforced threshold enforcement layer implemented in FPGA fabric, ensuring that even if the neural network produces a numerically erroneous output due to model drift or adversarial perturbation of input data, the FPGA threshold layer prevents any out-of-range value from reaching the clinical interface. All output vectors with a risk score exceeding the hardware-defined threshold of 0.05 are zeroed by the ASIC-Implemented Nullification Circuit before delivery, providing a hardware backstop that cannot be circumvented by software manipulation of the neural network or its outputs. SHAP (SHapley Additive exPlanations)-based feature attribution is computed within the TEE for every inference result, decomposing the model's output into per-feature contribution scores that identify which genomic, imaging, or clinical input features most strongly influenced the recommendation. These attribution visualizations are delivered to clinicians via the Therapy Risk Console alongside the primary risk assessment, satisfying EU AI Act Article 13 transparency and explainability requirements for high-risk AI systems in medical device applications. Outputs include modality-specific confidence intervals—separately quantifying uncertainty arising from genomic data, imaging data, and clinical record data—as well as structured contraindication flags that alert clinicians to specific safety concerns detected by individual predicates within the FPGA screening layer.

FIG. 3B—BIOMARKER SHIFT MONITOR: depicts the distributional monitoring subsystem that continuously tracks the statistical properties of incoming Biological Safety Predicate input distributions and detects clinically significant distributional shifts that may indicate model staleness, data pipeline drift, or changes in the underlying patient population. The monitor applies Kolmogorov-Smirnov (K-S) two-sample tests comparing the distribution of each predicate input variable observed over a rolling window against the reference distribution established during the most recent model validation cycle. The K-S test is configured to detect distributional shifts with at least 95% statistical sensitivity at a false positive rate consistent with Bonferroni-corrected significance thresholds across all simultaneously monitored predicate variables. When a statistically significant distributional shift is detected, the subsystem generates a structured shift event record documenting the affected predicate variable, the magnitude of the K-S test statistic, the p-value, the rolling window period during which the shift was observed, and the reference distribution against which the shift was measured. All detected shift events are immutably recorded in the Provenance Governance Ledger with hardware-attested timestamps, providing a longitudinal record of model input stability that can be reviewed by regulatory authorities during compliance audits. Repeated or large-magnitude shift events in critical predicate variables automatically trigger the Model Recalibration Initiator to begin a targeted gradient update cycle, ensuring that biological safety thresholds remain appropriately calibrated to the current patient population and clinical context without requiring manual monitoring intervention.

FIG. 3C—MODEL RECALIBRATION INITIATOR: depicts the incremental learning subsystem that selectively updates AI model parameters in response to detected biomarker distributional shifts or accumulated clinical outcome data, without requiring full model retraining from initialization. The subsystem employs targeted gradient update cycles—computing gradient updates exclusively over the layers and parameters most relevant to the shifted predicates—reducing model recalibration time by 70% relative to full retraining while maintaining equivalent calibration accuracy for the affected safety-relevant model components. Before any gradient update is applied to the production model, the update must be validated by a multi-signature cryptographic scheme requiring digital signatures from a cryptographic majority of authorized Governance Nodes, ensuring that no single administrator or compromised system can unilaterally modify safety-critical model parameters. Built-in regulatory alignment checks execute within the TEE to verify that the proposed recalibrated model continues to satisfy all active Biological Safety Predicates across the full distribution of historical test inputs before the update is certified for deployment. Pre-deployment simulation protocols run the recalibrated model against a held-out synthetic patient cohort—generated by the Adversarial Therapy Tester subsystem—to quantify the impact of the update on model outputs across the full range of clinically relevant input values before any recalibrated model version is accepted for network-wide deployment. All recalibration events, including the triggering shift event, the gradient update computation, multi-party approval signatures, regulatory alignment check results, and pre-deployment simulation outcomes, are recorded in the Provenance Governance Ledger with hardware-attested timestamps.

FIG. 3D—SECURE UPDATE DISSEMINATOR: depicts the secure model update distribution subsystem that propagates certified recalibrated model weights from the aggregation server to all participating clinical nodes over encrypted, authenticated channels while preserving the ability to cryptographically rollback any update that fails post-deployment attestation verification. Model weight updates are transmitted through onion-routed encrypted peer-to-peer channels that conceal transmission metadata—including source routing paths and message timing—from network-level observers, preventing traffic analysis attacks that might reveal which nodes are receiving security-relevant updates. Each transmitted update package includes a multi-party approval certificate comprising the digital signatures of all Governance Nodes that approved the recalibration, the hash of the pre-deployment simulation results, and the HSM-generated execution certificate from the recalibration TEE session. Receiving nodes verify the multi-party approval certificate and the integrity hash of the update package before applying the update to their local model repository; any verification failure triggers immediate rejection of the update and a report to the Provenance Governance Ledger. Versioned state management maintains the three most recent certified model versions at each node, enabling immediate cryptographic rollback to any prior version if a deployed update is subsequently found to produce anomalous predicate evaluation patterns across the distributed network. Pre-deployment simulation protocols—executed on a sandboxed model instance at the aggregation server before the update is transmitted—predict the expected distribution of predicate evaluation outcomes across the full range of clinical input scenarios, enabling operators to assess update safety before network-wide deployment.

FIG. 3E—REMOTE ATTESTATION VERIFIER: depicts the remote attestation subsystem that provides continuous, cryptographically verifiable assurance that every node in the distributed clinical network is executing the certified model version on unmodified, authorized hardware within a trusted execution environment. Attestation is implemented using Intel SGX or ARM TrustZone secure enclave technology, which generates signed attestation reports containing cryptographic hashes of all code and data loaded into the enclave at the time of attestation; these hashes are compared against a registry of certified software and hardware configurations maintained by the authorized Governance Node infrastructure. Attestation reports are generated and verified on a configurable schedule—by default at the start of each clinical session and after each model update—and can be requested on demand by regulatory auditors or network administrators. Failed attestation—indicating that a node is executing modified software, running on unauthorized hardware, or operating outside a certified TEE environment—automatically triggers immediate session key revocation for the non-attesting node and initiates the swarm propagation protocol to notify all peer nodes of the failed attestation event within one second. Hybrid cloud and on-premise deployment configurations are supported via FIDO2-compliant third-party attestation services, which provide a standardized attestation verification interface compatible with both SGX and TrustZone enclave technologies. Remote attestation records for every node, including attestation report hashes, verification outcomes, and any remediation actions taken in response to failed attestation, are stored in the Provenance Governance Ledger with hardware-attested timestamps for regulatory audit purposes.

FIG. 4—REGENERATIVE OUTPUT INTERFACE illustrates the five-subsystem clinical output and compliance layer through which hardware-validated AI inference results are translated into actionable clinical visualizations, longitudinal forecasts, therapeutic alignment assessments, auditable ledger queries, and automatically generated regulatory compliance packages.

FIG. 4A—THERAPY RISK CONSOLE: depicts the primary clinical visualization interface through which treating clinicians, research coordinators, and regulatory reviewers interact with hardware-validated AI inference outputs. Risk assessments are presented as multi-dimensional heat-maps rendering risk scores across anatomical regions, genetic variant categories, or time-series treatment windows, with color encoding calibrated to hardware-enforced risk thresholds so that any output suppressed by the ASIC Nullification Circuit is visually distinguished from validated outputs. All visualizations conform to WCAG 2.1 Level AA accessibility standards, ensuring that the interface is usable by clinicians with visual or motor accessibility requirements without compromising the information density necessary for clinical decision-making. Patient-profile-linked recommendations are generated by the FPGA Predicate Screening and Hardware Safety Evaluator subsystems and presented in the context of each patient's hardware-encoded safety profile, enabling clinicians to immediately identify which predicate constraints are active and which are approaching threshold values. Role-customizable dashboard layouts allow treating clinicians to prioritize real-time risk scores and contraindication flags, research coordinators to view cohort-level predicate statistics and drift monitoring alerts, and regulatory reviewers to access compliance certificates and audit trail summaries, each within a role-restricted view enforced by hardware-attested authentication. SHAP attribution visualizations are rendered inline with primary risk assessments, enabling clinicians to inspect the feature-level drivers of each recommendation and satisfy EU AI Act Article 13 transparency obligations at the point of clinical use.

FIG. 4B—THERAPY TRAJECTORY FORECASTER: depicts the longitudinal prediction subsystem that generates multi-horizon therapy trajectory forecasts with quantified uncertainty bounds, enabling clinicians and research coordinators to assess the projected evolution of regenerative therapy outcomes over configurable time horizons ranging from individual treatment sessions to multi-year longitudinal follow-up. Trajectory forecasts are generated using Monte Carlo simulation over the posterior distribution of AI model outputs conditioned on the current patient state and the most recent hardware-validated clinical measurements, producing forecast distributions that reflect both aleatoric uncertainty—inherent variability in biological processes—and epistemic uncertainty—uncertainty arising from limited training data coverage of the patient's specific clinical profile. Time-series visualization renders forecast distributions as fan charts displaying the median trajectory alongside configurable percentile bands, allowing clinicians to visually assess the range of plausible outcomes and identify scenarios in which biological safety predicates are at risk of future violation. FHIR R4-compliant exports package forecast results, confidence interval data, and associated provenance metadata into standardized resources that can be transmitted to Electronic Health Record systems via certified FHIR API connections, enabling bidirectional integration with Epic, Cerner, and other certified EHR platforms without requiring custom data transformation. All forecast generation events—including model version, patient state snapshot, simulation parameters, and output distributions—are logged to the Provenance Governance Ledger with hardware-attested timestamps, ensuring that forecasts used in clinical decision-making are permanently associated with the specific hardware-validated model state that produced them.

FIG. 4C—MULTIMODAL ALIGNMENT ASSESSOR: depicts the multimodal alignment evaluation subsystem that quantifies the degree to which the patient's current genomic, imaging, and clinical data profile aligns with validated therapeutic response patterns encoded in the AI model, providing structured alignment metrics that support therapeutic scenario planning and comparative effectiveness analysis. Alignment is measured along three primary dimensions—genomic sequence alignment, imaging phenotype alignment, and structured clinical record alignment—with each dimension scored independently by the Multimodal Fusion Lattice decomposition and reported as a sub-score enabling clinicians to identify which data modality is driving overall alignment or misalignment with validated response patterns. Sub-score decomposition enhances transparency by attributing the overall alignment assessment to specific feature combinations within each modality, supporting sensitivity analysis under varied clinical conditions—for example, quantifying how alignment changes if a borderline genomic variant is reclassified or if an imaging measurement is updated. Hypothetical scenario testing allows clinicians to input counterfactual patient data values—simulating proposed interventions or projected biomarker trajectories—and observe the corresponding change in alignment scores and predicate evaluation outcomes, supporting pre-intervention risk assessment without requiring actual patient data modification. All scenario testing is performed within the TEE, ensuring that hypothetical data values are cryptographically isolated from the patient's production data record and cannot contaminate the Provenance Governance Ledger audit trail with counterfactual values.

FIG. 4D—PROVENANCE AUDIT GATEWAY: depicts the ledger query interface through which authorized clinical, research, and regulatory personnel retrieve cryptographic proofs of audit events recorded in the Provenance Governance Ledger. The gateway employs query optimization algorithms—specifically, Merkle proof construction and cryptographic index pre-computation—to achieve sub-second retrieval of inclusion proofs for any individual audit record, enabling real-time verification of specific inference sessions, predicate evaluation outcomes, or revocation events during regulatory inspections without requiring full ledger traversal. Automated audit report generation assembles structured compliance packages—organized by reporting period, node identifier, model version, or regulatory framework—from ledger query results, reducing the manual effort required to prepare submissions for FDA, HIPAA, EU AI Act, or GDPR compliance audits. Role-based access controls enforce strict separation between clinical users—who may query inference session records for their own patients—research coordinators—who may query cohort-level aggregate statistics—and regulatory reviewers—who may query the complete audit trail for any node within their authorized scope—with access permissions cryptographically enforced by hardware-attested authentication at the HSM level. All gateway query events, including the querying user's hardware-attested identity, the query parameters, and the cryptographic proof returned, are themselves recorded in the Provenance Governance Ledger, creating a meta-audit trail of access to audit records that supports detection of unauthorized or anomalous data access patterns.

FIG. 4E—REGULATORY REPORT GENERATOR: depicts the compliance automation subsystem that continuously assembles, certifies, and schedules delivery of regulatory evidence packages satisfying the documentation requirements of multiple concurrent regulatory frameworks. The generator embeds HSM-generated certificates of execution integrity—cryptographic attestations that AI inference for each clinical session was performed on authorized hardware within a certified TEE, with all Biological Safety Predicates active and no suppressed output vectors delivered to clinical users—directly into evidence packages, providing regulators with hardware-rooted proof of compliance that cannot be fabricated by software alone. Evidence packages are structured to satisfy FDA RMAT designation requirements, 21 CFR Part 11 electronic records and audit trail standards, HIPAA Security Rule technical safeguard documentation requirements, EU AI Act (Regulation (EU) 2024/1689) Articles 9, 13, and 14 risk management, transparency, and human oversight documentation obligations, and GDPR Article 30 records of processing activities, with each package organized according to the specific section and subsection structure expected by the applicable regulatory authority. Evidence is compiled into standardized XML and PDF formats compatible with FDA electronic submission gateways and EU notified body documentation portals. Automated scheduling ensures that periodic compliance reporting—quarterly for HIPAA Security Rule reviews, annually for EU AI Act conformity assessments, and on-demand for FDA RMAT designation renewals—is completed and delivered without manual compilation effort. All report generation events are logged in the Provenance Governance Ledger with hardware-attested timestamps, creating a verifiable record of when each compliance package was generated and which ledger records it incorporated.

FIG. 5—SIMULATION PERFORMANCE EVALUATOR illustrates the five-subsystem framework through which the deployed system's robustness, benchmarked performance, adversarial resilience, drift-based maintenance scheduling, and external integration health are continuously measured, archived, and made available for regulatory and operational review.

FIG. 5A—SYSTEM ROBUSTNESS CALCULATOR: depicts the resilience evaluation subsystem that systematically quantifies the deployed system's ability to maintain hardware-enforced safety guarantees and clinical throughput under a comprehensive range of failure conditions. The subsystem applies Failure Mode and Effects Analysis (FMEA) methodology to enumerate potential failure modes across all hardware components—HSM failure, TEE attestation failure, FPGA fabric corruption, ASIC nullification circuit fault, gossip protocol partition, and ledger node unavailability—and prioritizes each failure mode by a Risk Priority Number (RPN) computed as the product of occurrence probability, detection difficulty, and severity of impact on patient safety outcomes. Monte Carlo simulations execute thousands of randomized failure scenario trials—varying the number, type, and timing of simultaneous component failures—to assess network-wide performance metrics including AI inference throughput, predicate evaluation latency, revocation propagation time, and ledger write availability under each degraded configuration. Simulation results are used to generate hardware redundancy recommendations specifying the minimum number of redundant HSM, TEE, and FPGA instances required at each deployment tier to maintain the 80% safe mode operational capacity guarantee under the most probable combination of concurrent failures identified by the FMEA analysis. All robustness evaluation runs—including the FMEA scoring tables, Monte Carlo simulation parameters, and output performance distributions—are archived in compressed, searchable formats in the Provenance Governance Ledger for longitudinal trend analysis and regulatory submission as evidence of ongoing AI system risk management under EU AI Act Article 9.

FIG. 5B—COHORT PERFORMANCE RANKER: depicts the benchmarking subsystem that normalizes and ranks the AI inference performance of each participating clinical node against federated benchmark distributions, enabling network administrators and research coordinators to identify nodes exhibiting anomalous performance patterns that may indicate hardware degradation, software configuration drift, or data quality issues. Local site performance scores—encompassing predicate evaluation latency, inference throughput, privacy budget consumption rate, revocation response time, and ledger write latency—are normalized against the federated distribution of corresponding metrics across all active nodes using z-score standardization, enabling meaningful comparison across sites with heterogeneous hardware configurations and patient volumes. Statistical significance testing using two-sample t-tests with Bonferroni correction determines whether any individual site's performance deviation from the federated benchmark is statistically significant or within expected random variation, triggering alerts and investigation workflows only for genuinely anomalous deviations. User-configurable metric weights allow network administrators to prioritize performance dimensions according to deployment context—weighting predicate evaluation latency most heavily for nodes supporting real-time surgical applications, privacy budget consumption for nodes contributing to high-sensitivity research coalitions, or ledger write latency for nodes supporting high-volume regulatory audit operations. Subgroup analysis disaggregates performance metrics by patient demographic categories—where permitted by applicable privacy regulations—to identify personalized medicine outcome disparities that may indicate model performance inequity across patient subpopulations, supporting fairness monitoring obligations under EU AI Act Article 9 risk management requirements.

FIG. 5C—ADVERSARIAL THERAPY TESTER: depicts the adversarial simulation subsystem that stress-tests the system's hardware-enforced safety guarantees against realistic worst-case clinical input scenarios, including high-noise measurement environments, data-scarce patient cohorts, adversarially crafted inputs designed to probe predicate boundary conditions, and coordinated multi-node failure events. Synthetic patient cohort data is generated using Generative Adversarial Network (GAN) models trained on de-identified clinical data distributions, producing synthetic records that accurately reproduce the statistical properties—including rare phenotype combinations and boundary-condition biomarker values—of the real patient population without containing any actual patient data. Adversarial inputs are constructed using gradient-based adversarial example generation methods applied to the AI model within a sandboxed TEE instance, identifying input perturbations that are small in magnitude but cause maximum deviation in predicate evaluation outcomes; these inputs are used to verify that FPGA predicate screening correctly classifies adversarially perturbed inputs as predicate violations rather than passing them to the clinical interface. The subsystem predicts model robustness under high-noise conditions—simulating measurement uncertainty distributions exceeding typical clinical ranges—and data-scarcity conditions—simulating patient cohorts with limited prior clinical history—by quantifying the degradation of AI inference confidence intervals and predicate evaluation accuracy under each stress scenario. Results are presented in tabular and graphical formats comparing system performance under nominal and adversarial conditions across all five primary performance dimensions, enabling research teams to identify specific predicate variables or patient subpopulations for which the system's hardware-enforced safety guarantees are most sensitive to input distribution perturbation.

FIG. 5D—MODEL EVOLUTION MONITOR: depicts the drift monitoring subsystem that applies time-series forecasting to AI model performance metrics to predict future performance degradation trends, schedule proactive recalibration before clinically significant degradation occurs, and maintain a longitudinal archive of model evolution suitable for regulatory audit of AI lifecycle management. The subsystem applies ARIMA (AutoRegressive Integrated Moving Average) models to time-series data for each key performance metric—predicate evaluation accuracy, inference confidence interval width, biomarker shift monitor K-S test statistics, and federated training loss curves—fitting separate ARIMA models to each metric series and generating multi-step-ahead forecasts with quantified uncertainty intervals. Forecast confidence intervals are compared against configurable degradation alert thresholds for each metric, with proactive maintenance alerts generated when the forecast lower bound of any metric's confidence interval crosses the alert threshold—providing advance warning of impending degradation before it becomes clinically observable. All tracked metrics, ARIMA model parameters, forecast outputs, and degradation alert events are archived in the Provenance Governance Ledger for regulatory traceability, creating a comprehensive longitudinal record of AI model performance evolution that satisfies post-market surveillance documentation requirements under EU AI Act Article 72 for high-risk AI systems. Predictive maintenance scheduling integrates with the Model Recalibration Initiator to automatically queue targeted gradient update cycles for predicted near-future degradation events, enabling recalibration to be completed during low-clinical-activity periods rather than reactively during periods of peak clinical demand.

FIG. 5E—EXTERNAL INTERFACE CONNECTOR: depicts the integration subsystem that exposes the system's AI inference, audit query, compliance reporting, and administrative control functions to authorized external systems through hardware-enforced, authenticated API endpoints. All external API connections require OAuth 2.0 authentication with hardware-attested client identity verification—specifically, the OAuth 2.0 client credential must be cryptographically signed by the requesting system's Sovereign Identity Token before the API gateway accepts the connection—ensuring that API access cannot be granted to unauthorized systems even if valid OAuth credentials are obtained through software-layer compromise. API endpoints are organized into three tiers: clinical integration endpoints supporting FHIR R4-compliant data exchange with Electronic Health Record systems for bidirectional inference result delivery and patient data ingestion; regulatory integration endpoints supporting standardized audit query and compliance report delivery to FDA submission gateways and EU notified body portals; and administrative endpoints supporting Governance Node management, model version control, and system health monitoring for authorized network administrators. Containerized deployment packages for each API tier support versatile integration across public cloud, private cloud, and on-premise clinical environments, with hardware-attested identity preserved across deployment boundary crossings through TEE-to-TEE attestation handshakes. Hardware-enforced API rate limiting at the HSM level prevents denial-of-service attacks and ensures equitable resource allocation during peak integration load, with rate limit policies configurable per client identity and endpoint tier without requiring software-layer policy enforcement that could be circumvented. All external API access events—including client identity, endpoint accessed, request parameters, and response metadata—are logged to the Provenance Governance Ledger with hardware-attested timestamps, creating a complete record of all external system interactions for security monitoring and regulatory audit purposes.

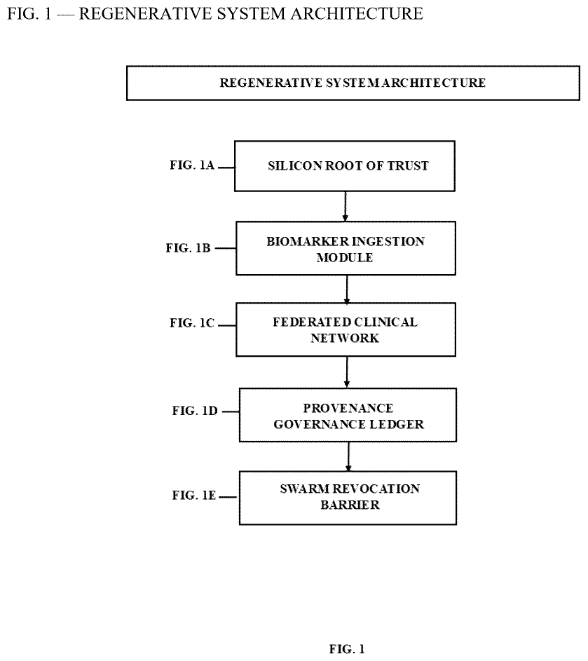

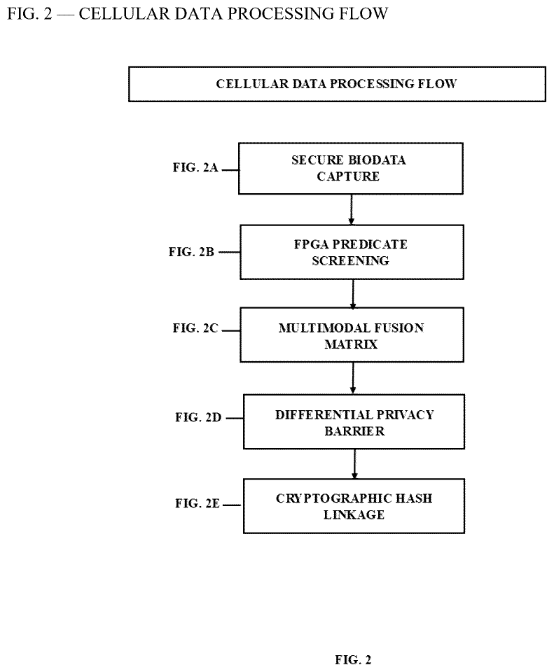

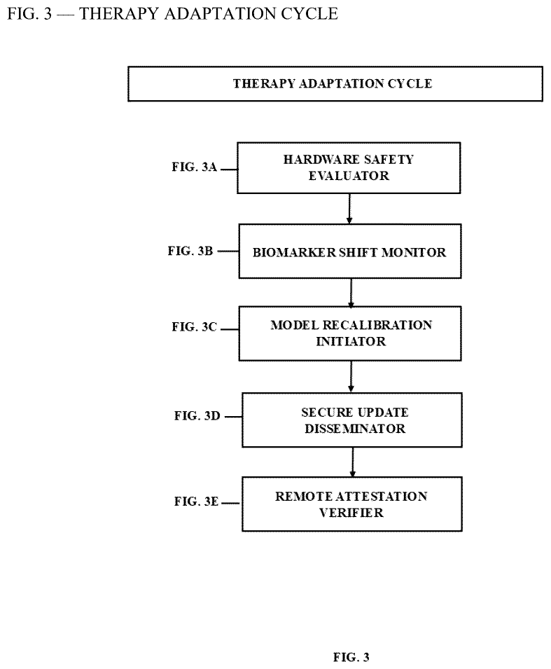

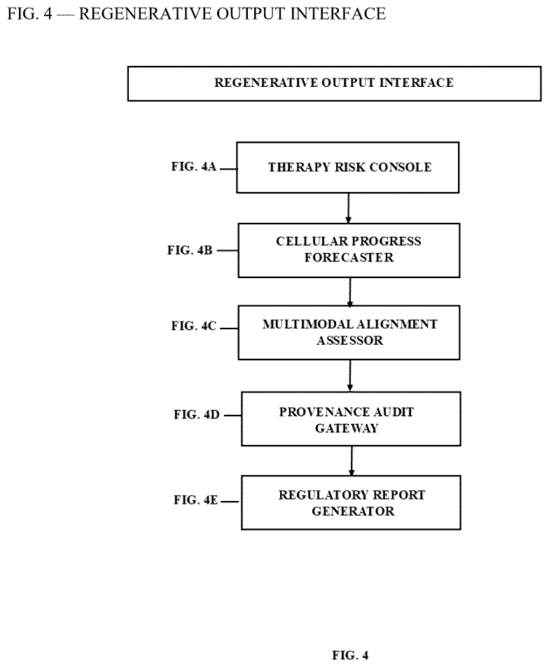

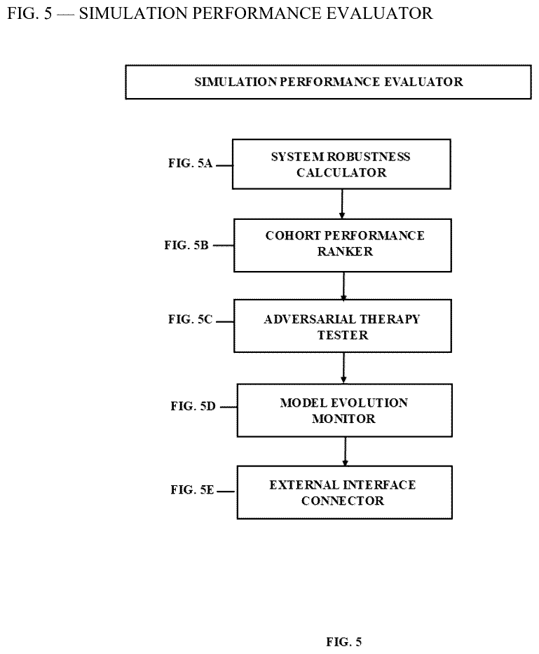

### DETAILED DESCRIPTION OF THE INVENTION

The following detailed description sets forth specific embodiments of the invention. It will be apparent to those skilled in the art that modifications and variations may be made to the described embodiments without departing from the scope of the claims.

### A. Silicon-anchored Execution Architecture

At the core of the present invention is the principle that AI model security in clinical settings cannot be achieved by software alone, but must be rooted in the physical properties of hardware. The HSM stores the Sovereign Identity Token—a PUF-derived identifier that is mathematically bound to the specific silicon instance. The PUF exploits sub-micron manufacturing process variations that are unique to each fabricated chip and cannot be replicated, even by the chip manufacturer, without access to the original silicon. Accordingly, the Sovereign Identity Token cannot be extracted by software attack, cloned by copying firmware, or reproduced on substitute hardware.

Model weights are stored in a Model Repository exclusively in AES-256-GCM ciphertext. The session-specific decryption key is derived from the PUF challenge-response and is volatile—it exists only within the TEE and is automatically erased upon power cycle, clock-drift exceedance, or after five minutes of inference inactivity. The decryption key is never present in system memory accessible to the host operating system. Accordingly, even a complete system memory dump yields only ciphertext.

The Safety Epoch mechanism provides defense against replay and hardware-substitution attacks. The TEE maintains an internal hardware-protected clock synchronized to a distributed Safety Epoch reference. If the internal clock deviates from the Safety Epoch by more than one second—indicating possible replay of an old session or substitution of the hardware platform—the TEE immediately and irreversibly erases all session key material, rendering ongoing inference cryptographically impossible until re-attestation and re-authentication are completed.

### B. Hardware-Executed Biological Safety Enforcement

Biological safety enforcement in the present invention is implemented at the hardware layer through FPGA-Based Predicate Logic and ASIC-Implemented Nullification Circuits. This architecture ensures that safety constraints are not subject to software override, even by privileged system processes.

The FPGA-Based Predicate Logic module evaluates a configurable set of Biological Safety Predicates—including cell viability score thresholds, differentiation risk indices, immunogenicity probability bounds, and genetic instability coefficients—against incoming inference outputs in real time. Evaluation latency is maintained below one millisecond because the predicates are implemented as combinational logic circuits in FPGA fabric, not as software routines subject to scheduling delays or OS preemption.

When any Biological Safety Predicate evaluates to a violation condition, the ASIC-Implemented Nullification Circuit issues an irreversible nullification signal within 10 milliseconds. This signal suppresses the AI output vector—specifically, all output vectors with a risk score exceeding 0.05 are zeroed before delivery to the clinical interface—and logs the violation event to the Provenance Governance Ledger with a hardware-attested timestamp. The ASIC implementation ensures that the nullification circuit cannot be disabled, bypassed, or delayed by any software layer, including operating system processes with root or kernel privilege.

Patient-specific biomarkers are incorporated into the nullification circuit binding via SHA-3-256 hash chaining, creating a unique cryptographic link between each patient's safety profile and the hardware enforcement circuit. This prevents cross-patient predicate substitution attacks in which an adversary might attempt to apply a less restrictive safety profile from one patient to another.

### C. Distributed Revocation With Sub-Second Propagation

The Sub-Second Revocation system addresses the challenge of rapidly invalidating compromised credentials across large distributed clinical trial networks. Existing certificate revocation mechanisms such as OCSP and CRL are too slow for clinical AI safety contexts, where a compromised node must be excluded from AI-assisted decisions within clinically relevant time frames.

The present invention employs a gossip-based swarm propagation protocol in which each node receiving a revocation signal immediately re-broadcasts to a randomized subset of its peer connections. This approach achieves network-wide propagation across up to 1,000 nodes in under one second with sub-500 millisecond median propagation latency, even in partially connected topologies representing network partitions or node failures. Mathematical analysis using epidemic spreading models confirms that the protocol achieves 99.9% coverage within 800 milliseconds for networks of up to 1,000 nodes with average node degree of 10.

Upon receiving a revocation signal, each node's Hardware Security Module immediately purges all current session key material within a hardware-enforced latency bound of 500 milliseconds. Hardware interlocks then disable HSM decryption operations, preventing any further AI inference, until a re-validation procedure is completed. Re-validation requires quorum consensus from at least 51% of active peer nodes that have not themselves been revoked, ensuring that a single compromised node cannot bootstrap its own re-authorization.

During the period between revocation propagation and hardware interlock engagement, and during hardware interlock periods more generally, the system maintains at least 80% operational capacity through a hardware-enforced safe mode that continues to serve previously validated inference results with appropriate clinical uncertainty flagging. This ensures that patient care is not abruptly interrupted by a security event in any single node.

### D. Federated Learning With Hardware-Enforced Privacy

The Decentralized Regen Network implements federated learning without raw data exchange. Each participating institution trains a local model instance on local patient data and contributes only gradient updates—not raw data—to the federated aggregation process. Gradient updates are encrypted using partially homomorphic encryption, allowing the aggregation server to compute gradient sums without decrypting individual contributions.

To prevent gradient inversion attacks that might reconstruct patient-identifiable data from gradient contributions, the Cell Privacy Barrier injects Gaussian noise calibrated to (epsilon, delta)-differential privacy guarantees, with epsilon and delta tuned to maintain model utility—measured as area under the ROC curve—within 2% of non-private training baselines.

All gradient update submissions are signed with the submitting node's Sovereign Identity Token, providing hardware-attested provenance for each federated contribution. The Provenance Governance Ledger records all federated training events with hardware-attested timestamps, enabling comprehensive audit of the model evolution history in a format satisfying 21 CFR Part 11 electronic records requirements.

### E. Regulatory Compliance Architecture

The present invention is designed from the silicon level upward to satisfy the requirements of FDA RMAT designation, 21 CFR Part 11, HIPAA Security Rule, EU AI Act (Regulation (EU) 2024/1689), and GDPR. The Regulatory Report Generator automates the compilation of compliance evidence packages including: (a) HSM-generated execution certificates for each inference session; (b) FPGA predicate evaluation logs with hardware-attested timestamps; (c) Provenance Governance Ledger entries constituting the complete audit trail from data ingestion through therapeutic output; (d) federated training provenance records; and (e) revocation event logs. These materials are compiled into standardized XML and PDF formats compatible with FDA electronic submissions.

The EU AI Act imposes requirements on high-risk AI systems in medical device applications including risk management documentation (Article 9), transparency and explainability (Article 13), and human oversight (Article 14). The present invention addresses all three: Article 9 through the hardware-enforced FMEA-based robustness evaluation subsystem; Article 13 through SHAP-based attribution outputs accessible via the Therapy Risk Console; and Article 14 through hardware-enforced suppression of output vectors that exceed risk thresholds, ensuring that potentially unsafe recommendations never reach clinicians without human review.

### DETAILED IMPLEMENTATION EMBODIMENTS

### Example 1: Clinical Deployment for Organ Regeneration

In a Hospital-based regenerative therapy center, edge computing nodes running the Execution Layer reduce end-to-end AI inference latency to under 100 milliseconds measured from raw data input to signed clinical output. The FPGA-Based Predicate Logic continuously monitors cell viability scores and differentiation risk indices for each processed patient cohort. When a cell viability score falls below the hardware-defined threshold, the ASIC Nullification Circuit issues a suppression signal within 10 milliseconds, logging the event to the Provenance Governance Ledger before any output reaches the clinical interface. Clinicians interact with the Therapy Risk Console, viewing SHAP-attributed risk heat-maps and confidence intervals. All session activity is continuously attested by the TEE, and any deviation from the Safety Epoch triggers immediate, automatic session key erasure and clinical alert. This embodiment demonstrates the integration of PUF-gated AI execution directly into regulated clinical workflows under FDA 21 CFR Part 11 and RMAT requirements.

### Example 2: Multi-Institutional Research Coalition

In a multi-site international stem cell research consortium spanning institutions in the United States and European Union, the system enables shared AI model training without raw patient data exchange. Each institution contributes differentially-private gradient updates signed with its node's Sovereign Identity Token. The federated aggregation server processes homomorphically encrypted gradient sums and distributes updated model weights to all participating nodes, each of which verifies the update via remote attestation before applying it. GDPR and HIPAA compliance is maintained through automated differential privacy parameter tuning and Provenance Governance Ledger documentation of all data flows. The system generates quarterly regulatory compliance packages in GDPR Article 30 and HIPAA audit log formats automatically, without manual report compilation.

### Example 3: Large-Scale Distributed Clinical Trial

For a Phase III clinical trial spanning more than 1,000 clinical sites, the system deploys sharded Provenance Governance Ledger nodes handling over 1 terabyte of daily audit data across the trial network. The adaptive quorum mechanism—using quorum size proportional to the square root of the active node count—reduces computational overhead by 40% relative to fixed-majority-quorum alternatives while maintaining equivalent Byzantine fault tolerance. When a site node is suspected of compromise, the Sub-Second Revocation protocol propagates credential invalidation to all 1,000 nodes within one second, and the compromised node's Hardware Security Module erases all session key material within 500 milliseconds of receiving the revocation signal. The safe mode protocol maintains 80% of trial data collection capacity during the revocation and re-validation period, preventing trial continuity disruption.

### Example 4: Gene Editing Safety Enforcement

In an ex vivo gene editing context employing CRISPR-based stem cell modification, the FPGA-Based Predicate Logic is configured to evaluate off-target editing probability scores and mosaicism indices against hardware-defined thresholds specific to each patient's genetic profile. The patient-specific biomarker binding in the ASIC Nullification Circuit ensures that safety thresholds are cryptographically tied to the individual patient's Sovereign Identity Token, preventing the application of a permissive threshold profile to a patient for whom a restrictive profile is indicated. All editing approval decisions are logged with HSM-attested signatures to the Provenance Governance Ledger, providing a complete chain of custody from genomic input data through therapeutic approval.

### Example 5: Defense and Sovereign AI Deployment

In national security contexts requiring verifiable AI sovereignty, the present invention provides hardware-rooted assurance that AI inference cannot occur on unauthorized hardware regardless of software compromise. The PUF-based Sovereign Identity Token architecture is designed to support compliance with NIST SP 800-193 Platform Firmware Resilience and FIPS 140-3 Level 4 requirements for physical security of cryptographic modules. Remote attestation via TEE provides continuous verification of platform integrity to monitoring authorities without requiring physical inspection of deployed hardware.

What is claimed is:

1: A silicon-anchored system for hardware-gated artificial intelligence execution in regenerative medicine, comprising:
a Hardware Security Module (HSM) storing a Sovereign Identity Token permanently bound to device silicon via a Physical Unclonable Function (PUF) that exploits unique silicon manufacturing variations at the device level;
a Model Repository storing AI model weights exclusively in AES-256-GCM ciphertext, wherein plaintext model weights are inaccessible outside the Execution Layer;
a Trusted Execution Environment (TEE) configured to prevent model decryption when an internal hardware-protected clock deviates from a synchronized Safety Epoch timestamp by more than one second, and to irreversibly erase all session key material upon detection of such deviation;
a decryption gate requiring a PUF-derived session key such that execution of the AI model on any hardware other than the native silicon instance produces only cryptographically invalid output;
a predicate evaluation module implemented in FPGA logic gates, configured to evaluate a plurality of Biological Safety Predicates against AI inference outputs at sub-millisecond latency without reliance on a host operating system;
an ASIC-Implemented Nullification Circuit hardwired to suppress AI output vectors that fail any Biological Safety Predicate within 10 milliseconds of predicate evaluation;
a cryptographic binding interface incorporating patient-specific biomarkers into the ASIC-Implemented Nullification Circuit via SHA-3-256 hash chaining, such that safety enforcement is device-bound and patient-specific;
a hardware-enforced revocation module configured to purge all session key material within a bounded latency of 500 milliseconds upon receiving a revocation signal;
a swarm propagation protocol implementing gossip mechanisms to propagate revocation signals to networks of up to 1,000 nodes in under one second; and
a hardware-enforced safe mode maintaining at least 80% operational capacity of clinical AI inference during partial network degradation following a revocation event.

2: A method for silicon-anchored artificial intelligence execution with hardware-enforced biological safety in regenerative medicine, comprising:
generating, by a Physical Unclonable Function (PUF) circuit exploiting silicon manufacturing variations, a Sovereign Identity Token uniquely and permanently bound to a specific silicon instance;
storing, in a Hardware Security Module (HSM), AI model weights exclusively in AES-256-GCM ciphertext;
monitoring, by a hardware-protected clock within a Trusted Execution Environment (TEE), deviation of a local clock signal from a synchronized Safety Epoch timestamp, and irreversibly erasing all session key material when said deviation exceeds one second;
gating model decryption exclusively by a PUF-derived session key, such that model inference on any hardware other than the native silicon instance is cryptographically impossible;
evaluating, by FPGA logic gate circuits, a plurality of Biological Safety Predicates against AI inference outputs at sub-millisecond latency;
issuing, by an ASIC-Implemented Nullification Circuit within 10 milliseconds of detecting any Biological Safety Predicate violation, an irreversible suppression signal that zeros all output vectors exceeding a risk score threshold of 0.05;
logging each suppression event to a Provenance Governance Ledger with a hardware-attested timestamp;
receiving a revocation signal at a network node and purging all session key material within 500 milliseconds via the node's Hardware Security Module; and
propagating the revocation signal via gossip-based swarm communication to reach all nodes in a network of up to 1,000 nodes within one second, while maintaining at least 80% clinical AI inference capacity through a hardware-enforced safe mode.

3: A hardware-anchored federated learning and provenance system for distributed clinical AI networks, comprising:
a federated learning subsystem that aggregates AI model gradient updates from a plurality of clinical nodes using partially homomorphic encryption, wherein each gradient contribution is cryptographically signed with the contributing node's Sovereign Identity Token bound to device silicon via a Physical Unclonable Function (PUF);
a differential privacy enforcement module injecting calibrated Gaussian noise into gradient contributions to maintain (epsilon, delta)-differential privacy guarantees while preserving model utility within 2% of non-private training baselines;
a Provenance Governance Ledger implemented as a permissioned blockchain requiring multi-party digital signatures from a cryptographic majority of authorized Governance Nodes for any modification to core system logic, and recording all federated training events with hardware-attested timestamps; and
a Regulatory Report Generator that automatically compiles HSM-generated execution integrity certificates, FPGA predicate evaluation logs, and Provenance Governance Ledger entries into standardized evidence packages satisfying at least one of: FDA RMAT designation requirements; 21 CFR Part 11 audit trail standards; HIPAA Security Rule; EU AI Act Articles 9, 13, and 14; and GDPR Article 30.

4: The system of claim 1, wherein bypass of the silicon-anchored execution requires computational effort equivalent to at least 2\hat{ }128 operations simultaneously against all hardware security layers, quantified under current NIST cryptographic standards.

5: The system of claim 1, wherein the session-specific decryption key is volatile and is automatically erased upon any of: a power cycle event; detection of a Safety Epoch deviation exceeding one second; or five minutes of continuous AI inference inactivity.

6: The system of claim 1, further comprising a Provenance Governance Ledger implemented as a permissioned blockchain requiring multi-party digital signatures from a cryptographic majority of authorized Governance Nodes for any modification to core system logic.

7: The system of claim 1, wherein the plurality of Biological Safety Predicates comprises at least one of: a cell viability score threshold; a differentiation risk index bound; an immunogenicity probability limit; a genetic instability coefficient threshold; and a therapy contraindication flag evaluated against a patient-specific hardware-encoded profile.

8: The system of claim 1, further comprising a Multimodal Fusion Lattice performing tensor decomposition of genetic sequence data, medical imaging tensors, and structured clinical records under hardware-enforced safety constraints at O(n log n) computational complexity.

9: The system of claim 1, further comprising a Validation Layer comprising a hardware threshold comparison engine configured to refine Biological Safety Predicate thresholds based on federated clinical outcome data without requiring full model retraining.

10: The system of claim 1, wherein re-authorization of a revoked node requires quorum consensus from at least 51% of active peer nodes that have not themselves been revoked.

11: The system of claim 1, further comprising integration with external biometric sensors via secure Bluetooth Low Energy protocols, wherein biometric readings are incorporated into session key derivation for multi-factor hardware authentication.

12: The system of claim 1, further comprising a remote attestation subsystem employing Intel SGX or ARM TrustZone enclaves, wherein failed attestation automatically triggers immediate session key revocation and initiates the swarm propagation protocol.

13: The system of claim 1, further comprising a Regulatory Report Generator configured to compile evidence packages satisfying EU AI Act Articles 9, 13, and 14 requirements for high-risk AI systems in medical device applications.

14: The method of claim 2, further comprising compiling, by a Regulatory Report Generator, a compliance evidence package comprising HSM-generated execution certificates, FPGA predicate evaluation logs, and Provenance Governance Ledger entries, and formatting said package in compliance with at least one of: FDA RMAT designation requirements; 21 CFR Part 11; HIPAA Security Rule; EU AI Act Article 9; and GDPR Article 30.

15: The method of claim 2, further comprising detecting, by a Biomarker Shift Monitor employing Kolmogorov-Smirnov statistical testing, a distributional shift in one or more Biological Safety Predicate input distributions with at least 95% statistical sensitivity, and recording each detected shift event in the Provenance Governance Ledger with a hardware-attested timestamp.

16: The method of claim 2, wherein the Sovereign Identity Token is organized in a hierarchical structure supporting federated deployment across up to 10,000 hardware nodes in a multi-site clinical network, with each node's token cryptographically derivable from a root trust anchor maintained by an authorized certificate authority.

17: The method of claim 2, further comprising incorporating patient-specific biomarkers into the ASIC-Implemented Nullification Circuit via SHA-3-256 hash chaining, such that biological safety enforcement is cryptographically bound to an individual patient's hardware-encoded safety profile.

18: The system of claim 3, further comprising a Validation Layer comprising a hardware threshold comparison engine configured to refine federated model parameters based on aggregated clinical outcome data without requiring full model retraining at any participating node.

19: The system of claim 3, wherein the Provenance Governance Ledger employs cryptographic sharding to handle audit data volumes exceeding 1 terabyte daily across trial networks of 1,000 or more nodes, while maintaining sub-second query response times via query optimization and cryptographic proof retrieval.

20: The system of claim 3, further comprising a Biomarker Shift Monitor employing Kolmogorov-Smirnov statistical testing to detect distributional changes in federated input data with at least 95% sensitivity, and logging all detected shift events with hardware-attested timestamps to the Provenance Governance Ledger.
